(19) United States
(12) Patent Application Publication
(10) Pub. No.: US 2024/0144144 A1
(43) Pub. Date: May 2, 2024

(54) MACHINE-GENERATED PROCESS TRANSFORMATION

(71) Applicant: INTERNATIONAL BUSINESS MACHINES CORPORATION, Armonk, NY (US)

(72) Inventors: Radha Mohan De, Howrah (IN); Soumya Nandy, Bangalore (IN); Amitabha Mitra, Kolkata (IN)

(21) Appl. No.: 17/975,571

(22) Filed: Oct. 27, 2022

(51) Int. Cl. G06Q 10/06

(52) U.S. Cl. CPC G06Q 10/06393

(57) ABSTRACT

Process transformation can include mapping, by a first machine learning model, predetermined key performance indicators (KPIs) to a discovered process model. For each of the KPIs, a KPI gap and a KPI impact score can be determined. For each of the KPIs, a KPI-level enhancement potential value based on the KPI gap and KPI impact score of each KPI can be determined. Based on the KPI-level enhancement potential value of each of the KPIs, a process value debt (PVD) can be generated. Responsive to the PVD exceeding a predetermined threshold, a process transformation recommendation generated by a second machine learning model can be outputted to identify at least one modification to the process that is likely to reduce the PVD.

### TECHNICAL FIELD

This disclosure relates to process mining, and more particularly, to automated techniques for improving operational processes based on computer-generated event data.

### BACKGROUND

Process mining encompasses a variety of computer-implemented techniques for modeling and analyzing operational processes based on event data that is captured in event logs. Typically, event data includes a unique identifier and corresponding description of each distinct event of a process. Event data corresponding to a distinct event of the process can be timestamped and electronically recorded in an event log. Information recorded as event data can include, for example, the resources used, and the costs incurred in performing the process, as well as other process-related attributes. Process discovery is a process mining technique that transforms event data into a model of the process. Conformance checking is another process mining technique, which can be used in analyzing comparisons between the process model and an event log to discover and identify any discrepancies between the actual performance of the process and the model version of the process. Performance analysis is still another process mining technique, which can be used in attempting to improve the process model with respect to certain performance metrics.

### SUMMARY

In one or more embodiments, a method for transforming operational processes can include mapping, by a first machine learning model, predetermined key performance indicators (KPIs) to a discovered process model, wherein the discovered process model is created by process mining of event data that is retrieved from one or more event logs generated in response to computer-tracked activities associated with a process. The method can include determining, for each of the KPIs, a KPI gap and a KPI impact score, wherein each KPI gap is based on a difference between an observed KPI value and a baselined KPI value, and wherein each KPI impact score is based on a plurality of scaled impact values corresponding to a plurality of predetermined performance metrics for the process. The method can include generating, for each of the KPIs, a KPI-level enhancement potential based on the KPI gap and the KPI impact score of each KPI, and, based on the KPI-level enhancement potential of each of the KPIs, generating a process value debt (PVD) for the process. Responsive to the PVD exceeding a predetermined threshold, the method can include identifying by a second machine learning model one or more process transformations likely to reduce the PVD and determining a process transformation propensity (PTP) score for each of the one or more process transformations. The method can include outputting a process transformation recommendation recommending at least one of the one or more process transformations selected based on the PTP score of each of the one or more process transformations.

In one or more embodiments, a system for transforming an operational process includes one or more processors configured to initiate operations. The operations can include mapping, by a first machine learning model, KPIs to a discovered process model, wherein the discovered process model is created by process mining of event data that is retrieved from one or more event logs generated in response to computer-tracked activities associated with a process. The operations can include determining, for each of the KPIs, a KPI gap and a KPI impact score, wherein each KPI gap is based on a difference between an observed KPI value and a baselined KPI value, and wherein each KPI impact score is based on a plurality of scaled impact values corresponding to a plurality of predetermined performance metrics for the process. The operations can include generating, for each of the KPIs, a KPI-level enhancement potential based on the KPI gap and the KPI impact score of each KPI, and, based on the KPI-level enhancement potential each of the KPIs, generating a PVD for the process. Responsive to the PVD exceeding a predetermined threshold, the operations can include identifying by a second machine learning model one or more process transformations likely to reduce the PVD and determining a PTP score for each of the one or more process transformations. The operations can include outputting a process transformation recommendation recommending at least one of the one or more process transformations selected based on the PTP score of each of the one or more process transformations.

In one or more embodiments, a computer program product includes one or more computer readable storage media having instructions stored thereon. The instructions are executable by a processor to initiate operations. The operations can include mapping, by a first machine learning model, KPIs to a process model, wherein the process model is created by process mining of event data retrieved from one or more event logs generated in response to computer-tracked activities associated with a process. The operations can include determining, for each of the KPIs, a KPI gap and a KPI impact score, wherein each KPI gap is based on a difference between an observed KPI value and a baselined KPI value, and wherein each KPI impact score is based on a plurality of scaled impact values corresponding to a plurality of process performance metrics for the process. The operations can include generating, for each of the KPIs, a KPI-level enhancement potential based on the KPI gap and the KPI impact score of each KPI, and, based on the KPI-level enhancement potential of each of the KPIs, generating a PVD for the process. Responsive to the PVD exceeding a predetermined threshold, the operations can include identifying by a second machine learning model one or more process transformations likely to reduce the PVD and determining a PTP score for each of the one or more process transformations. The operations can include outputting a process transformation recommendation recommending at least one of the one or more process transformations selected based on the PTP score of each of the one or more process transformations.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example system for transforming operative processes.

FIG. 2 illustrates certain methodological aspects of using the system of FIG. 1.

FIGS. 3A-3F illustrate example machine outputs generated in accordance with certain operative aspects of the system of FIG. 1.

FIGS. 4A and 4B illustrate an example method of transforming operative processes.

FIG. 5 illustrates an example computing environment for implementing aspects of the system of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to process mining, and more particularly, to automated techniques for improving operational processes based on computer-generated event data. As noted above, process mining can be used in an effort to improve a process based on performance analysis. The improvement based on such analysis, however, often requires human effort on the part of a consultant or other individual, and thus, can depend to a large extent on the skill, intuition, and/or subjectivity of a human expert or other individual involved.

In accordance with the inventive arrangements disclosed herein, example methods systems, and computer program products are provided that are capable of automating the transformation of various types of processes. The various types of processes comprise an orchestrated and repeatable pattern of activities that are enabled by systematically organizing the activities into processes that, for example, process information, transform materials, and/or render services. The process, for example, can be an enterprise-level process, such as a computer-based procurement system.

An aspect of the inventive arrangements disclosed is the leveraging of process mining combined with artificial intelligence (AI) to quantify the potential for improving a process and unlocking the potential by identifying transformations that improve the operations of the process. Using machine learning, the inventive arrangements can map key performance indicators (KPIs) to a process model generated by the process mining of event logs generated in response to execution of the process. A machine-generated process value debt quantifies the potential for improving the process, and a machine-generated process transformation propensity generates specific transformations recommendations to capture the improvement potential.

The role of the process value debt, in certain contexts, mirrors that of a technical debt in software engineering, in that as the process is transformed, the process value debt is reduced. Thus, another aspect of the inventive arrangements is generating a process value debt to quantify the uncaptured or unlocked potential for improving the process. A zero process value debt can thus indicate that, given current considerations and constraints, the process cannot be further improved through transformation. The inventive arrangements also can identify KPIs for improvement. Applied iteratively, the inventive arrangements can continue to transform a process until, eventually, all or a significant amount of the enhancement potential of the process has been captured.

Another aspect of the inventive arrangements is a machine learning determination of the specific manner that the one or more of the KPIs can be improved. The inventive arrangements can identify discrepancies between a process as currently configured and an idealized model of the process. Implementing machine learning, the inventive arrangements are capable of identifying transformations that eliminate or mitigate the discrepancies, effecting a corresponding improvement in one or more KPIs of the process. The transformations, in certain arrangements, can be determined using a machine learning separate from the one that performs the mapping. The machine learning model, in certain arrangements, is a supervised-learning model that is trained to identify discrepancies between a process as currently configured and an idealized version represented by a process model. Based on the identification of discrepancies, the machine learning model generates one or more recommendations. Each recommendation is for a specific transformation that improves the process and captures as-yet unlocked potential. The transformation can pertain to a specific step in the process and recommend some corresponding modification of the process with respect to the specific step.

In some embodiments, the specific machine learning model used is a novel machine learning model, denoted as a subtract/optimize/divide/add (SODA) model, a machine learning model. Trained through supervised learning, the SODA model recognizes discrepancies between the execution of a process and an idealized version (e.g., process model) and recommends a transformation by classifying the discrepancies. A transformation, based on the classification according to the SODA model, removes (subtracts) a step from the process, optimizes a step, divides a step into two or more steps, or adds a new step to the existing steps.

Yet another aspect of the inventive arrangements is a machine-generated process transformation propensity score. The transformation propensity score can quantify the degree to which each transformation improves the process. Based on the process transformation propensity score, the inventive arrangements can output one or more transformation recommendations for improving the process.

Certain of the inventive arrangements perform a computer-based mapping of the KPIs to predetermined process excellence (PEX) value triangle parameters. PEX is a strategy whereby an enterprise (e.g., a public or private organization) develops and adapts processes in the context of one or more prescribed goals (e.g., maximize productivity or minimize costs or enhance stakeholder experience or SLA adherence). Using a PEX strategy, an enterprise can assess, modify, and test a process performance until the process meets certain goals. A PEX strategy thus enables the enterprise to continually improve the process by updating its design, introducing innovations, and implementing better tools and approaches. PEX value triangle categories of Efficiency, Compliance, and Experience provide a common lens and industry-agnostic frame for viewing organizational (e.g., business enterprise) KPIs. All of an organization's KPIs can be placed in one of the three categories, which are mutually orthogonal KPI dimensions. Thus, the PEX layer can help drive non-technical benefits, such as business strategy, enterprise performance, and the like.

Accordingly, PEX can specify PEX parameters. PEX parameters are a type of predetermined performance metric. As defined herein, “performance metric” means a quantifiable variable for measuring performance of a process. A “process model,” as defined herein, means a model of the process. The process model can be discovered by a process mining exercise (using a process mining tool) from event data that is retrieved from one or more event logs generated in response to computer-tracked activities of the process.

Further aspects of the inventive arrangements described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

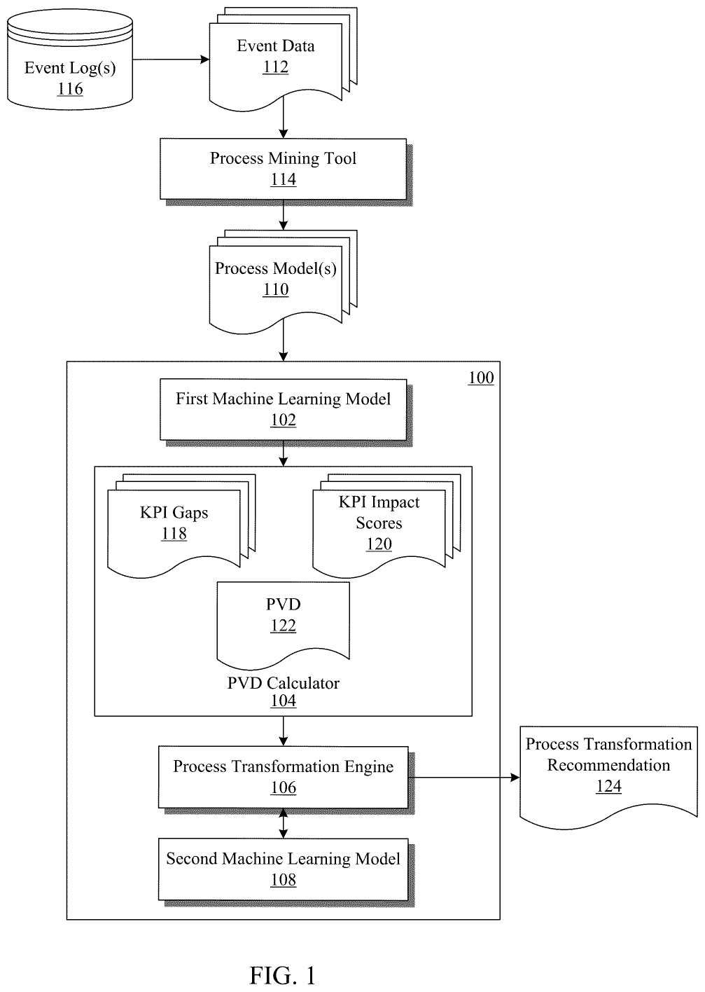

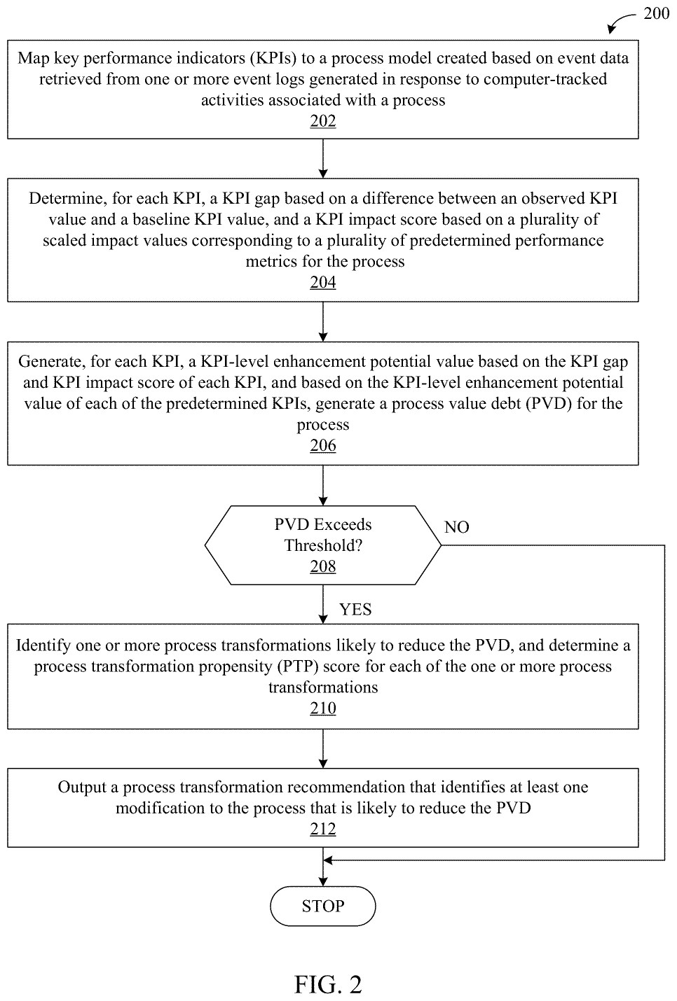

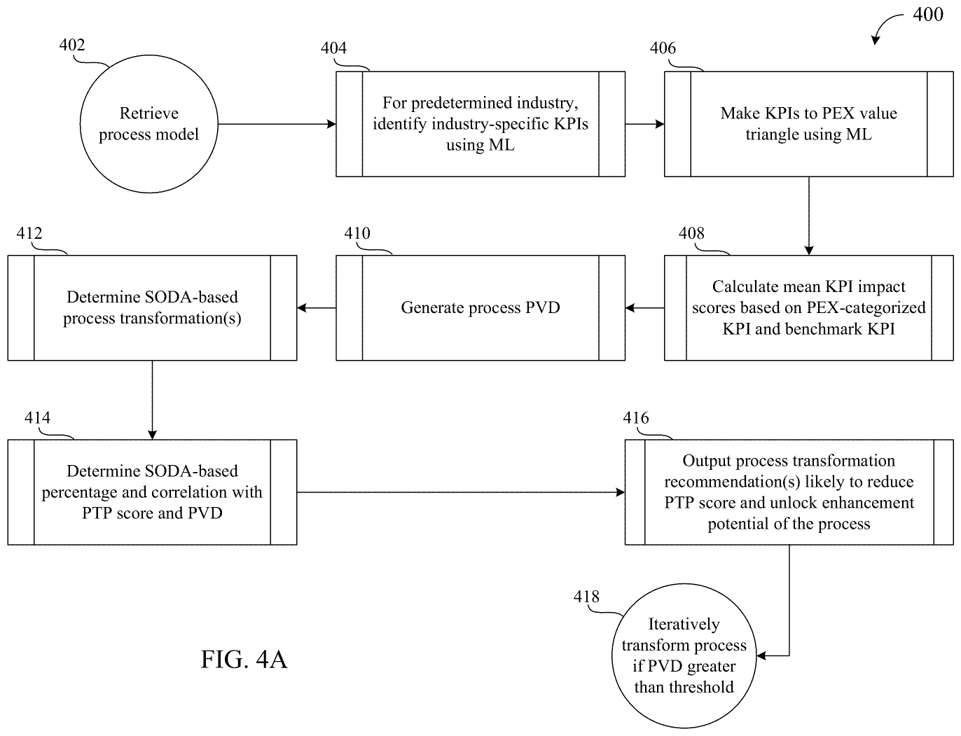

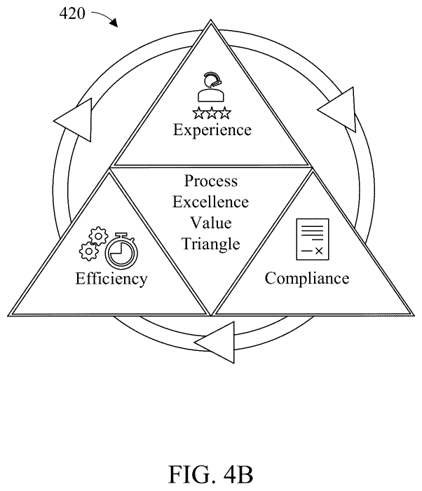

Referring initially to FIGS. 1 and 2, an example process transformation system (system) 100, and a methodology 200 of implementing certain operative aspects of the disclosure are illustrated. System 100 can be operatively coupled with, or integrated in, a process mining tool or other computer-implemented system that is configured to enhance an operative process of an enterprise or other multi-person organization or individual. In various arrangements, system 100 illustratively includes first machine learning model 102, process value debt (PVD) calculator 104, process transformation engine 106, and second machine learning model 108. First machine learning model 102, PVD calculator 104, process transformation engine 106, and second machine learning model 108 of system 100 can be implemented in hardware (e.g., dedicated hardwired circuitry), software (e.g., program code executed by one or more processors), or a combination thereof. For example, system 100 in certain embodiments may be implemented in computer-readable program instructions loaded onto a computer, such as computer 401 of computing environment 400 (FIG. 4).

System 100 can map a set of KPIs identified through machine learning to a model of a process. The model can be discovered by process mining of event data obtained from one or more event logs generated in response to computer-based tracking of process activities. Based on the KPIs, system 100 can determine a process value debt that quantifies the potential that can be unlocked to improve the process. System 100, based on a process transformation propensity score determined from the KPIs, can output specific recommendations for improving the operative process. System 100 can iteratively perform the process until the full potential for improvement of the operational process has been captured.

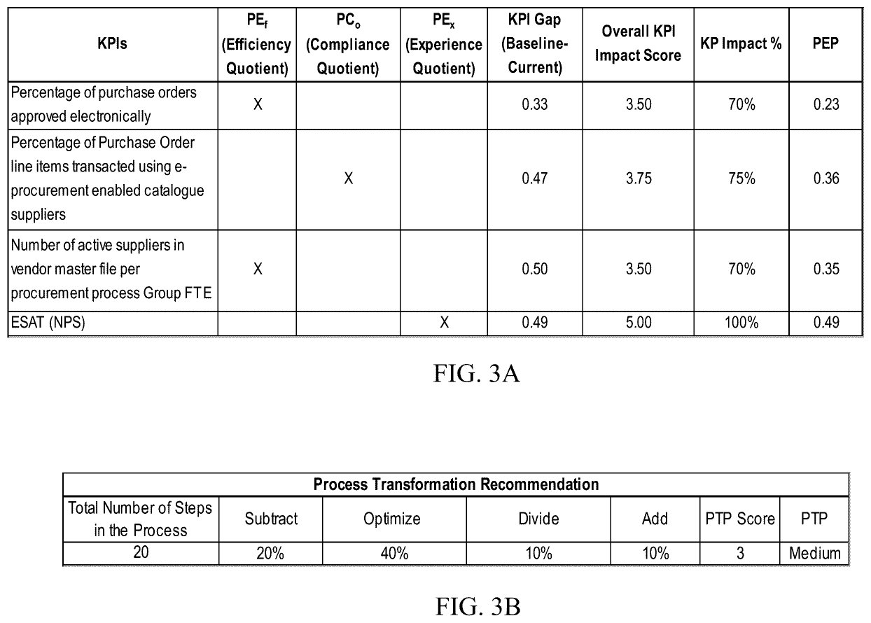

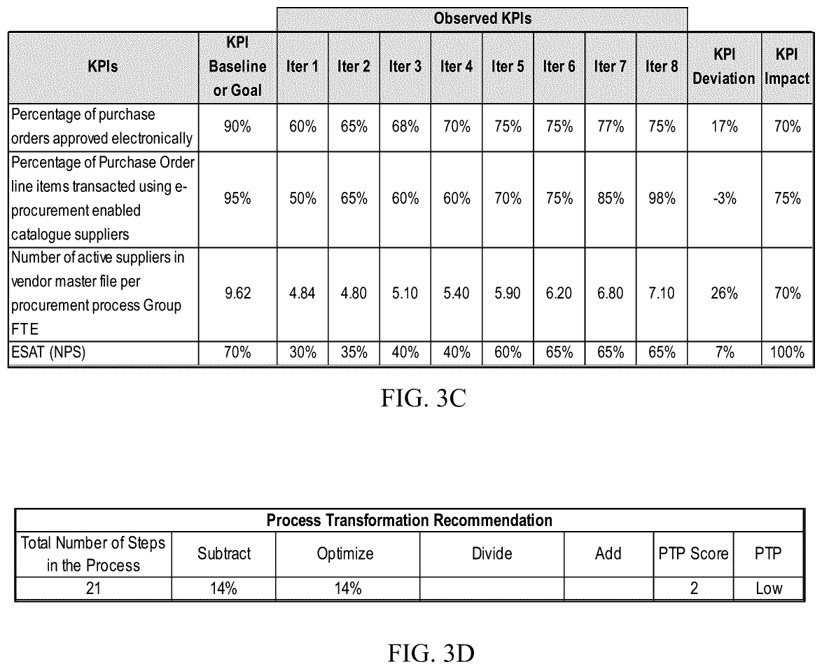

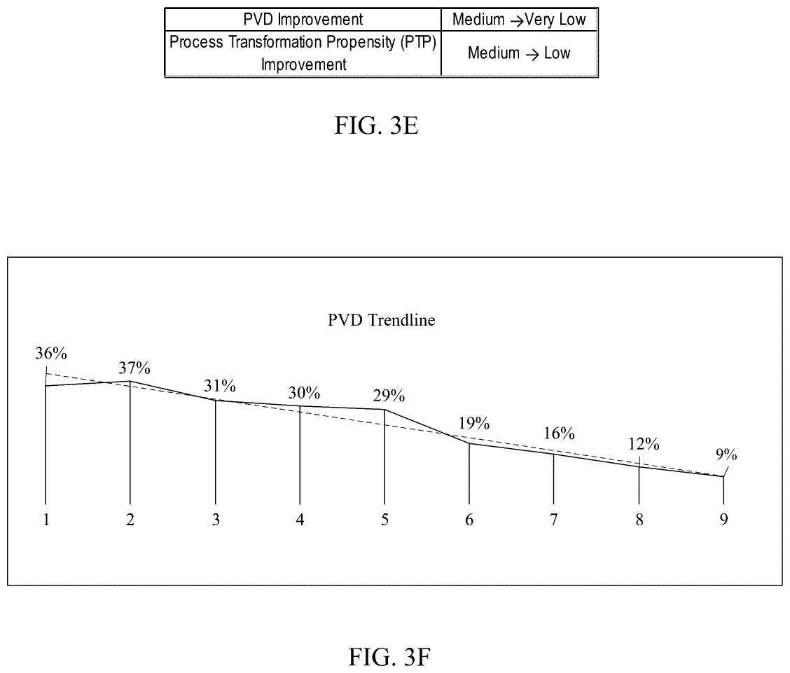

Operatively, at block 202, first machine learning model 102 is capable of mapping a set of KPIs to process model 110. Process model 110 is “discovered” in the sense that the model is computer-generated based on event data 112 generated through an operational process. Event data 112 is data having a predetermined data structure that is acquired from various sources for measuring one or more events or activities associated with the operational process modeled by process model 110. Illustratively, event data 112 is retrieved, timestamped, and processed by process mining tool 114. Process mining tool 114 retrieves event data 112 from one or more event logs 116. Event log(s) 116 electronically store event data 112, which illustratively is generated in response to computer-tracked activities that collectively comprise the operational process modeled by process model 110. The operational process, for example, can be an enterprise process such as a procurement process (FIGS. 3A-3F) or other enterprise-level process.

In certain arrangements, first machine learning model 102 is a supervised learning model, such as a deep learning neural network. First machine learning model 102 can be trained through supervised learning to recognize patterns that, based on a set of labeled training examples, correspond to one or more models of operational processes that are the same or similar to the operational process modeled by process model 110. Accordingly, first machine learning model 102 maps to process model 110 the KPIs of the one or more process models that are identified as the same or similar to the process modeled by process model 110. The KPIs can be derived from standard industry practices associated with one or more processes of a specific industry. The specific industry can be the industry to which the enterprise or other entity that performs the operational process model modeled by process model 110 belongs. Moreover, first machine learning model 102 can be trained to categorize each of the KPIs. First machine learning model 102 can categorize the KPIs by assigning each of the KPIs to a PEX category, which can be one of multiple such categories. In different arrangements, different PEX categories can be implemented by first machine learning model 102 for categorizing KPIs. Illustratively, the PEX categories are: efficiency; experience; and compliance. First machine learning model 102, accordingly, categorizes each KPI mapped to process model 110 as an efficiency KPI, an experience KPI, or a compliance KPI. The category of a KPI corresponds to which aspect—efficiency, experience, or compliance—of a given PEX strategy the KPI has the greatest impact on. First machine learning model 102 feeds the KPIs that are mapped to process model 110 into PVD calculator 104.

At block 204, PVD calculator 104 is capable of determining KPI gaps 118 and KPI impact scores 120 for each of the KPIs mapped to process model 110. Each of the KPI gaps 118 corresponds to the difference between a baselined value of a KPI and an observed value of the KPI. The baselined value of a KPI, in some arrangements, is an industry average of the KPI. In other arrangements, the baselined value is a goal set by the enterprise or other entity that carries out the process modeled by process model 110. An observed value of a KPI is determined based on monitoring (e.g., in real time) process activities associated with the KPI.

In certain arrangements, the baselined and observed values of the KPIs can be expressed as percentages. As a percentage, each KPI's baselined value, denoted BASELINED KPI %, is a function of the relative impact percentage of an industry specific KPI on a process. That is, BASELINED KPI %=f(relative impact percentage of industry specific KPI). Each KPI's observed value, denoted OBSERVED KPI %, likewise is a function of the relative impact percentage of PEX parameter based KPI. That is, OBSERVED KPI %=f(relative impact percentage of KPI). Accordingly, the KPI gaps 118 of the process also can be represented as a percentage, denoted KPI GAP %. The percentage corresponds to the proportional amount that, or the degree to which, the process (as currently configured) fails to match the corresponding baselined value of the KPI. That is, KPI GAP %=(BASELINED KPI %−OBSERVED KPI %)/BASELIINED KPI %. Thus, the percentage is the residual, or gap, between a desired percentage level and observed percentage level given the current configuration of the process. For example, a procurement process KPI may be the percentage of an enterprise's purchases that are approved electronically. If the BASELINED KPI % is 80 percent and the OBSERVED KPI % is 60 percent, then the KPI GAP % is 25 percent.

Each of the KPI impact scores 120, denoted KPI IMPACT SCORE, is a function of each KPI's proportional impact on the process, which in turn is based on an average of a KPI's impact on certain predetermined performance metrics. That is, KPI IMPACT SCORE=(proportional impact of KPI on predetermined performance metrics). The impact of a KPI can be scaled (e.g., between 0 (no impact) and 5 (maximum impact)). Thus, each of KPI impact scores 120 can be based on a plurality of scaled impact values corresponding to a plurality of predetermined performance metrics for the process. Different performance metrics can be specified in various combinations with respect to a process. In certain arrangements, the performance metrics are: revenue; profitability; free cash flow; stakeholder experience; and compliance adherence. Each KPI impact score is an average of the KPI's impact on each of the performance metrics. Consider, for example, the afore-mentioned procurement process KPI based on the percentage of purchases approved electronically. If the scaled impact of the KPI on profitability, free cash flow, stakeholder experience, and compliance adherence, are 3, 3, 4, and 4, respectively, and zero otherwise, then the KPI IMPACT SCORE of the KPI is 3.5. A percent KPI impact score, denoted KPI IMPACT %, is the percentage of the KPI impact score relative to a maximum scaled value. For example, given a 3.5 KPI IMPACT SCORE relative to a scale maximum of 5, yields a KPI IMPACT % of 70 percent.

At block 206, PVD calculator 104 is capable of generating, for each of the KPIs, a KPI-level enhancement potential based on the KPI gap and KPI impact score of each KPI. Based on the KPI-level enhancement potential of each of the KPIs, PVD calculator 104 is capable of generating PVD 122 for the process. A KPI-level enhancement potential value of each KPI is generated by PVD calculator 104 based on the KPI gaps 118 and KPI impact scores 120 of the different KPIs. A KPI-level enhancement potential value of an individual KPI is equal to the product of the KPI GAP % and the KPI IMPACT % of the KPI.

(KPI GAP %)*(KPI IMPACT %).

PVD 122 can be generated by PVD calculator 104 based on the aggregate KPI-level enhancement potentials of the KPIs of the process. Specifically, in certain arrangements, PVD 122 is an average of the KPI-level enhancement potentials of the KPIs of the process. PVD 122 provides a system-generated quantitative measure of how much improvement can be captured for the process based on one or more process transformations. The higher PVD 122 is, the greater the opportunity to improve the process by a transformation that increases one of more KPIs of the process.

At block 208, if PVD 122 exceeds a predetermined threshold (e.g., zero), then at block 210 second machine learning model 108 is capable of identifying one or more process transformations that are likely to reduce r 122 if implemented. Process transformation engine 106 is capable of determining a process transformation propensity (PTP) score for each of the one or more process transformations identified by second machine learning model 108.

At block 210, process model 110 can serve as a reference model to which execution of the modeled process as currently configured is compared by process transformation engine 106. Process transformation engine 106 can identify points of non-conformance between process model 110 and execution of the modeled process as currently configured. Identified points of non-conformance are input by process transformation engine 106 to second machine learning model 108.

In certain arrangements, second machine learning model 108 implements a SUBTRACT/OPTIMIZE/DIVIDE/ADD (SODA) model. The SODA model is a machine learning model trained through supervised learning to predict transformation potential of the modeled process and to recommend process transformations based on the input of identified non-conformities of the modeled process as currently configured. A process transformation can recommend subtracting, optimizing, dividing, or adding a step to the process. A SUBTRACT recommendation eliminates a redundant step from the modeled process if, as currently configured, the process include multiple identical or similar steps. Multiple identical or similar steps may be due to user customizations, errors, and/or exceptions. Eliminating redundant steps can reduce lead times and wait times associated with the process, as well as mitigate delay costs. An OPTIMIZE recommendation reengineers a specific step of the process based on a static or dynamic optimization technique. A DIVIDE recommendation splits an existing step into two or more steps that more enhance overall efficiency of the process. An ADD recommendation either adds a new step or combines and consolidates two or more steps to enhance the overall efficiency of the process.

Process transformation engine 106, in certain arrangements, utilizes various process volumetrics generated by process mining tool 114. Process transformation engine 106 uses the data to determine a total number of steps of the process. Process transformation engine 106 can determine a process transformation type for the process transformation recommendation. A process transformation recommendation percentage can be determined by process transformation engine 106. Process transformation engine 106 can generate a process transformation recommendation percentage (e.g., SODA percentage) based on the total number of steps and process transformation type. For example, a subtract percentage corresponding to a SODA-based process transformation recommendation to remove a step from a process can be determined by dividing the number of process steps identified for removal by total number process steps. Process transformation engine 106 can generate the PTP score based on the process transformation recommendation percentage.

At block 212, process transformation engine 106 is capable of outputting process transformation recommendation 124. Process transformation recommendation 124 recommends at least one of the one or more process transformations selected based on the PTP score of each of the one or more process transformations determined by process transformation engine 106 at block 210. In certain arrangements, a process transformation recommendation, based on identifying and classifying of a discrepancy, can identify one or more specific steps (e.g., events, activities) of the process, as well as how each should be modified (e.g., eliminated, combined, optimized) to transform the process. The process transformation recommendation also can identify one or more new steps to be introduced into the process and at what stage of the process each should be introduced.

System 100 can repeat the procedure of blocks 202 through 212. Through a number of iterations, as long as system 100 determines that PVD 122 is greater than a threshold (e.g., zero), there remains a potential for improving the process through further transformation. With each iteration, system 100 can output a process transformation recommendation recommending steps for modifying the process to improve one or more identified process KPIs of the process.

Optionally, system 100 can operate on multiple process models of an enterprise or other entity, each of the multiple process models modeling one or more processes. Based on system 100's performing the procedures described at blocks 202 through 212, process transformation engine can generate a PTP score for each process model and recommend the processes that are best candidates for transformation. The recommendations can be ranked based on the respective PTP scores of each of the multiple process models. The ranking thus indicates the relative potential for improvement of each of the processes. Process transformation engine 106 outputs the list of PTP scores to guide the enterprise or other entity in transforming multiple processes as warranted.

In certain arrangements, machine learning model 108 is trained to implement the above-described SODA model using inputs comprising process conformance data. Process conformance data is generated by comparing event data retrieved from event logs with a selected reference model. Based on the comparison, correlations (strong and weak) between the event data and the reference model can be determined. Conformance statistics can be derived from the correlations. In a specific application, the extent to which a process is automated can be determined based on user profiles executing the process. Process transformation propensity can be quantified based on the conformance statistics and extent of process automation. Applicability of an appropriate SODA-based transformation can be determined from the process transformation propensity and used to train the SODA-based machine learning model. Over time, the SODA-based machine learning model, using various reference models and conformance data, can be trained with respect to specific processes, industries, and/or geographies.

FIGS. 3A-3F illustrate certain machine outputs of system 100, the system used in an example context. Illustratively, the example context is an enterprise procurement process. System 100 can operate cooperatively with, or be integrated in, a process mining tool that enables the enterprise to acquire a comprehensive and coherent view of the procurement process, including expenditures (e.g., payment to suppliers) and other budgeting factors. The procurement process can be analyzed, and as needed, enhanced to whatever extent possible to meet predetermined performance metrics. Illustratively, the predetermined performance metrics include revenue, profitability, free cash flow, stakeholder experience, and compliance adherence. A process mining tool mines activities in one or more event logs pertaining to the procurement process. Event data is recorded and timestamped by the process mining tool, which uses the event data to discover one or more process models. A process model generated by the process mining tool captures details for analyzing procurement process flows. The process model can be built by leveraging event data pertaining to different variants, cycle times, and KPIs mapped to the process model.

Using industry data, system 100 determines baselined KPIs and generates multidimensional data structures to categorize each KPI in one or more PEX categories. The dimensions illustratively include efficiency, experience, and compliance. An observed KPI value corresponding to each baselined KPI is obtained by the process mining based on the event data. The baseline value of a KPI illustratively establishes an objective or goal. Computer-based tracking of process execution generates for each KPI an observed value of the corresponding KPI, the observed value indicating the extent to which that goal is met using the current configuration of the procurement process. FIG. 3A illustrates an example machine output, shown for example on a computer screen or on a hardcopy output. Columns 2, 3, and 4 of FIG. 3A indicate the KPIs along each of the predetermined dimensions (efficiency, experience, and compliance). The KPI Gap, Overall KPI Impact Score, KPI Impact Percentage, and PVD, respectively, are indicated in columns 5, 6, 7, and 8 of the machine output shown in FIG. 3A.

The PVD juxtaposed with deviations from the baselines automatically reveals opportunities to improve the procurement process with respect to the identified KPIs. FIG. 3B illustrates another example machine output. The machine output illustrated in FIG. 3B is a process transformation recommendation generated by system 100 based on the deviations. The PVD directly correlates with the system-generated PTP of the procurement process. Column 1 of the machine output in FIG. 3B indicates the number of steps of the procurement process. Columns 2, 3, 4, and 5 provide distinct recommendations for eliminating steps (column 2), optimizing steps (column 3), breaking a step into separate ones (column 4), and adding new steps (column 5). Each of the columns provides a percentage assigned to the corresponding recommendation generated by system 100. The process PTP score in column 6 of the machine output in FIG. 3B provides a scaled quantification of the potential for improving the procurement process through the recommended transformation of the different steps. Qualitatively, the PTP is characterized as a medium transformation potential as indicated in column 7 of the machine output in FIG. 3B.

There is a direct correlation between the PVD and the PTP. A decrease in PVD corresponds to the capture of at least a portion of the enhancement potential by implementing the recommended process transformation(s). Comparing the amount of potential captured against the baseline goals reveals the degree of success in improving the procurement process that is achieved through one or more process transformations. As a succession of transformations are made, the change in the PVD and PTP scores quantifies the iterative improvement in the procurement process with each transformation. FIG. 3C illustrates a machine output showing an iterative improvement in the process through eight iterations (columns 3 through 10).

FIG. 3D illustrates a machine output providing a new set of process transformation recommendations generated after a series of prior transformations have been implemented. Note that, as expected if each successive transformation captures a share of the potential for improvement, the lower PTP scores (columns 6 and 7) in the machine output in FIG. 3D as compared with the machine output in FIG. 3B. As illustrated by the machine output shown in FIG. 3E, the PVD has declined from medium to very low, and the PTP is reduced from medium to low. System 100 can provide a visualization of the iterative improvement with the machine output in FIG. 3F, which is a plot of a trendline of the PVD over nine iterations.

FIGS. 4A and 4B illustrate an example method 400 of transforming operative processes. Method 400 can be implemented by a system the same or similar to system 100.

At block 402, the system retrieves a process model generated by a process mining tool applied with respect to a process implemented by an enterprise or other entity. At block 404, given the industry associated with the enterprise or other entity, the system identifies a set of industry-specific KPIs using a machine learning model. At block 406, the system maps the KPIs to PEX value triangle 420, illustrated in FIG. 4B. The mapping generates PEX-categorized KPIs. Illustratively, PEX value triangle 420 comprises three vertices corresponding, respectively, to efficiency, experience, and compliance. In certain arrangements, PEX value triangle 420 can be displayed visually on a machine (e.g., computer screen) such that the size changes with changes in a system-generated PVD and system-determined PTP, becoming smaller, for example, as more enhancement potential is captured through successive process transformations.

At block 408, the system calculates a mean KPI impact scores based each PEX-categorized KPI and each corresponding benchmark KPI. At block 410, based on the calculations, the system generates a PVD for the modeled process. At block 412, the system determines one or more SODA-based process transformations. At block 414, the system determines a SODA-based percentage expressing the portion of the process that changes by implementing the SODA-based process transformations. The percentage correlates with the PVD and a PTP score. At block 416, the system outputs process transformation recommendations based on the PTP score. The process transformation(s) recommended are ones determined by the system to likely reduce the PTP score (and, accordingly, the PVD) and to unlock enhancement potential of the process. Optionally, the system, at block 418, iteratively transforms the process if the PVD is greater than a predetermined threshold (e.g., zero). For example, with a PVD threshold of zero, if the PVD is reduced to zero, then the system determines that there is no further enhancement potential to be achieved by further transformations of the modeled process.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the inventive methods. The inventive methods performed with the computer code of block 550, which can include implementing procedures for transforming an operative process based on event data retrieved from one or more event logs generated in response to computer-tracked activities associated with the operative process, as described herein in the context of system 100 and methodology 200. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 506, cloud orchestration module 541, host physical machine set 542, virtual machine set 543, and container set 544.

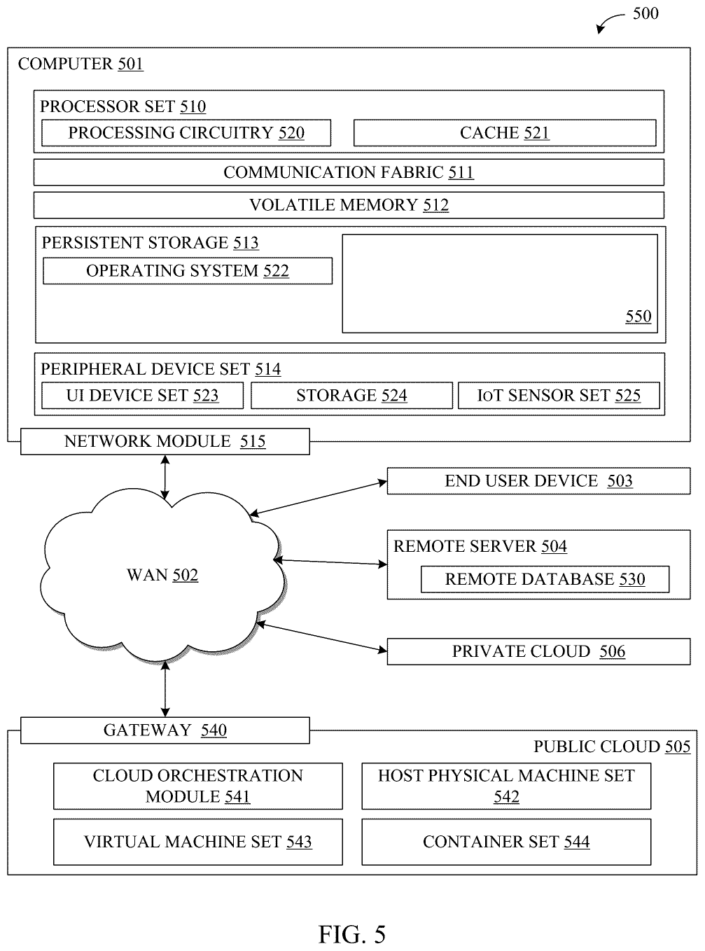

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (e.g., where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (e.g., embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (e.g., a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The terminology used herein is for the purpose of describing particular embodiments only and is not intended to be limiting. Notwithstanding, several definitions that apply throughout this document now will be presented.

As defined herein, the singular forms “a,” “an,” and “the” include the plural forms as well, unless the context clearly indicates otherwise.

As defined herein, “another” means at least a second or more.

As defined herein, “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, “automatically” means without user intervention.

As defined herein, “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, “if” means “in response to” or “responsive to,” depending upon the context. Thus, the phrase “if it is determined” may be construed to mean “in response to determining” or “responsive to determining” depending on the context. Likewise, the phrase “if [a stated condition or event] is detected” may be construed to mean “upon detecting [the stated condition or event]” or “in response to detecting [the stated condition or event]” or “responsive to detecting [the stated condition or event]” depending on the context.

As defined herein, “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the phrases “in response to” and “responsive to” mean responding or reacting readily to an action or event. Thus, if a second action is performed “in response to” or “responsive to” a first action, there is a causal relationship between an occurrence of the first action and an occurrence of the second action. The phrases “in response to” and “responsive to” indicate the causal relationship.

As defined herein, “user” and “end user” mean a human being.

The terms first, second, etc. may be used herein to describe various elements. These elements should not be limited by these terms, as these terms are only used to distinguish one element from another unless stated otherwise or the context clearly indicates otherwise.

The inventive arrangements disclosed herein have been presented for purposes of illustration and are not intended to be exhaustive or limited to the specific ones disclosed. Many modifications and variations will be apparent to those of ordinary skill in the art without departing from the scope and spirit of the described inventive arrangements. The terminology used herein was chosen to best explain the principles of the inventive arrangements, the practical application or technical improvement over technologies found in the marketplace, or to enable others of ordinary skill in the art to understand the inventive arrangements disclosed herein.

What is claimed is:

1. A computer-implemented method, comprising:
mapping, by a first machine learning model, key performance indicators (KPIs) to a process model, wherein the process model is discovered by process mining event data retrieved from one or more event logs generated in response to computer-tracked activities associated with a process;
determining, for each of the KPIs, a KPI gap and a KPI impact score, wherein each KPI gap is based on a difference between an observed KPI value and a baselined KPI value, and wherein each KPI impact score is based on a plurality of scaled impact values corresponding to a plurality of predetermined performance metrics for the process;
generating, for each of the KPIs, a KPI-level enhancement potential based on the KPI gap and KPI impact score of each KPI, and based on the KPI-level enhancement potential of each of the KPIs, generating a process value debt (PVD) for the process;
responsive to the PVD exceeding a predetermined threshold, identifying by a second machine learning model one or more process transformations likely to reduce the PVD and determining a process transformation propensity (PTP) score for each of the one or more process transformations; and
outputting a process transformation recommendation recommending at least one of the one or more process transformations selected based on the PTP score of each of the one or more process transformations.

2. The computer-implemented method of claim 1, further comprising:
determining a second PVD in response to modifying the process in accordance with the process transformation recommendation;
generating a second process transformation recommendation in response to determining that the second PVD is greater than the predetermined threshold; and
outputting the second process modification recommendation.

3. The computer-implemented method of claim 1, wherein the process transformation recommendation includes at least one of a recommendation to eliminate a process step identified as a redundant step of the process, a recommendation to restructure a process step based on an optimization determination, a recommendation to split an existing process step into two or more steps, or a recommendation to introduce a new step into the process.

4. The computer-implemented method of claim 1, further comprising:
using process volumetrics from the process mining to determine a total number of steps of the process;
determining a process transformation type of the process transformation recommendation;
generating a process transformation recommendation percentage based on the total number of steps and process transformation type; and
generating the PTP score based on the process transformation recommendation percentage.

5. The computer-implemented method of claim 1, wherein the mapping maps each of the KPIs to at least one of a plurality of categories, each of the plurality of categories indicating a predetermined process activity type.

6. The computer-implemented method of claim 5, wherein the plurality of categories includes an efficiency category, an experience category, and a compliance category.

7. The computer-implemented method of claim 1, wherein each baselined KPI value of each of the plurality of KPIs is based on an industry-wide standard for a predetermined industry.

8. A system, comprising:
a processor configured to initiate operations, the operations including:
mapping, by a first machine learning model, key performance indicators (KPIs) to a discovered process model, wherein the discovered process model is created by process mining event data retrieved from one or more event logs generated in response to computer-tracked activities associated with a process;
determining, for each of the KPIs, a KPI gap and a KPI impact score, wherein each KPI gap is based on a difference between an observed KPI value and a baselined KPI value, and wherein each KPI impact score is based on a plurality of scaled impact values corresponding to a plurality of predetermined performance metrics for the process;
generating, for each of the KPIs, a KPI-level enhancement potential based on the KPI gap and KPI impact score of each KPI, and based on the KPI-level enhancement potential of each of the KPIs, generating a process value debt (PVD) for the process;
responsive to the PVD exceeding a predetermined threshold, identifying by a second machine learning model one or more process transformations likely to reduce the PVD and determining a process transformation propensity (PTP) score for each of the one or more process transformations; and
outputting a process transformation recommendations recommending at least one of the one or more process transformations selected based on the PTP score of each of the one or more process transformations.

9. The system of claim 8, wherein the processor is configured to initiate operations further including:
determining a second PVD in response to modifying the process in accordance with the process transformation recommendation;
generating a second process transformation recommendation in response to determining that the PVD is greater than the second PVD; and
outputting the second process modification recommendation.

10. The system of claim 8, wherein the process transformation recommendation includes at least one of a recommendation to eliminate a process step identified as a redundant step of the process, a recommendation to restructure a process step based on an optimization determination, a recommendation to split an existing process step into two or more steps, or a recommendation to introduce a new step into the process.

11. The system of claim 8, wherein the processor is configured to initiate operations further including:
using process volumetrics from the process mining to determine a total number of steps of the process;
determining a process transformation type of the process transformation recommendation;
generating a process transformation recommendation percentage based on the total number of steps and process transformation type; and
generating the PTP score based on the process transformation recommendation percentage.

12. The system of claim 8, wherein the mapping maps each of the KPIs to at least one of a plurality of categories, each of the plurality of categories indicating a predetermined process activity type.

13. The system of claim 12, wherein the plurality of categories includes an efficiency category, an experience category, and a compliance category.

14. A computer program product, the computer program product comprising:
one or more computer-readable storage media and program instructions collectively stored on the one or more computer-readable storage media, the program instructions executable by a processor to cause the processor to initiate operations including:
mapping, by a first machine learning model, key performance indicators (KPIs) to a discovered process model, wherein the discovered process model is created by process mining event data retrieved from one or more event logs generated in response to computer-tracked activities associated with a process;
determining, for each of the KPIs, a KPI gap and a KPI impact score, wherein each KPI gap is based on a difference between an observed KPI value and a baselined KPI value, and wherein each KPI impact score is based on a plurality of scaled impact values corresponding to a plurality of predetermined performance metrics for the process;
generating, for each of the KPIs, a KPI-level enhancement potential based on the KPI gap and KPI impact score of each KPI, and based on the KPI-level enhancement potential of each of the KPIs, generating a process value debt (PVD) for the process;
responsive to the PVD exceeding a predetermined threshold, identifying by a second machine learning model one or more process transformations likely to reduce the PVD and determining a process transformation propensity (PTP) score for each of the one or more process transformations; and
outputting a process transformation recommendations recommending at least one of the one or more process transformations selected based on the PTP score of each of the one or more process transformations.

15. The computer program product of claim 14, wherein the program instructions are executable by the processor to cause the processor to initiate operations further including:
determining a second PVD in response to modifying the process in accordance with the process transformation recommendation;
generating a second process transformation recommendation in response to determining that the PVD is greater than the second PVD; and
outputting the second process modification recommendation.

16. The computer program product of claim 14, wherein the process transformation recommendation includes at least one of a recommendation to eliminate a process step identified as a redundant step of the process, a recommendation to restructure a process step based on an optimization determination, a recommendation to split an existing process step into two or more steps, or a recommendation to introduce a new step into the process.

17. The computer program product of claim 14, wherein the program instructions are executable by the processor to cause the processor to initiate operations further including:
using process volumetrics from the process mining to determine a total number of steps of the process;
determining a process transformation type of the process transformation recommendation;
generating a process transformation recommendation percentage based on the total number of steps and process transformation type; and
generating the PTP score based on the process transformation recommendation percentage.

18. The computer program product of claim 14, wherein the mapping maps each of the KPIs to at least one of a plurality of categories, each of the plurality of categories indicating a predetermined process activity type.

19. The computer program product of claim 18, wherein the plurality of categories includes an efficiency category, an experience category, and a compliance category.

20. The computer program product of claim 14, wherein each baselined KPI value of each of the plurality of KPIs is based on an industry-wide standard for a predetermined industry.
